(19) United States
(12) Patent Application Publication
(10) Pub. No.: US 2025/0191854 A1
(43) Pub. Date: Jun. 12, 2025

(54) SOLID ELECTROLYTIC CAPACITOR AND MANUFACTURING METHOD THEREOF

(71) Applicant: TOKIN CORPORATION, Shiroishi-shi (JP)

(72) Inventors: Kazuaki SAITO, Shiroishi-shi (JP); Masami ISHIJIMA, Shiroishi-shi (JP); Satoshi IWAI, Shiroishi-shi (JP); Hitoshi TAKATA, Shiroishi-shi (JP)

(73) Assignee: TOKIN CORPORATION, Shiroishi-shi (JP)

(21) Appl. No.: 18/962,806

(22) Filed: Nov. 27, 2024

(30) Foreign Application Priority Data
Dec. 11, 2023 (JP) 2023-208482

(51) Int. Cl. H01G 11/86; H01G 11/26; H01G 11/56

(52) U.S. Cl. CPC H01G 11/86; H01G 11/26; H01G 11/56

(57) ABSTRACT

A solid electrolytic capacitor can be manufactured by a manufacturing method comprising a facing step and a welding step. The solid electrolytic capacitor comprises an anode body, an anode lead and an anode lead frame. The anode lead extends forward from a front surface of the anode body in a front-rear direction. The anode lead frame has a standing portion. In the facing step, a predetermined region on a rear surface of the standing portion and a front end of the anode lead are faced to each other. In the welding step, the standing portion and the front end of the anode lead are welded to each other by radiating a laser beam toward the predetermined region of the standing portion from a radiation point which is located above the standing portion in an up-down direction perpendicular to the front-rear direction and is located rearward of the standing portion.

### CROSS REFERENCE TO RELATED APPLICATIONS

This application is based on and claims priority under 35 U.S.C. § 119 to Japanese Patent Application No. JP 2023-208482 filed Dec. 11, 2023, the content of which is incorporated herein in its entirety by reference.

### BACKGROUND OF THE INVENTION

This invention relates to a solid electrolytic capacitor comprising an anode body, an anode lead and an anode lead frame.

This type of solid electrolytic capacitor is disclosed in JP 5078827 B (Patent Document 1), the content of which is incorporated herein by reference.

Patent Document 1 discloses a solid electrolytic capacitor comprising an anode body, an anode wire (anode lead) and an anode terminal (anode lead frame). The anode body has a front end provided with an organic electrolyte layer. The organic electrolyte layer is covered by a light reflection layer. The anode lead frame is located forward of the light reflection layer. The anode lead projects forward through the light reflection layer. The anode lead is laser-welded to the anode lead frame. According to Patent Document 1, the light reflection layer provided as described above prevents damage of the organic electrolyte layer which might be caused by reflection of the laser beam during the laser-welding, and thereby the solid electrolytic capacitor can be prevented from being degraded in characteristics.

### SUMMARY OF THE INVENTION

There is a need for new technique which enables an anode lead and an anode lead frame of a solid electrolytic capacitor to be laser-welded to each other while preventing the solid electrolytic capacitor from being degraded in characteristics.

It is therefore an object of the present invention to provide a new manufacturing method of a solid electrolytic capacitor in which an anode lead is laser-welded to an anode lead frame and which is suitable for manufacturing a solid electrolytic capacitor having superior characteristics. It is also an object of the present invention to provide a solid electrolytic capacitor which has an anode lead laser-welded to an anode lead frame and which has superior characteristics.

An aspect of the present invention provides a manufacturing method of a solid electrolytic capacitor comprising an anode body, an anode lead and an anode lead frame. The anode lead extends forward from a front surface of the anode body in a front-rear direction. The anode lead frame has a standing portion. The manufacturing method comprises a facing step and a welding step. In the facing step, a predetermined region on a rear surface of the standing portion and a front end of the anode lead are faced to each other. In the welding step, the standing portion and the front end of the anode lead are welded to each other by radiating a laser beam toward the predetermined region of the standing portion from a radiation point which is located above the standing portion in an up-down direction perpendicular to the front-rear direction and is located rearward of the standing portion.

Another aspect of the present invention provides a solid electrolytic capacitor comprising an anode body, an anode lead and an anode lead frame. The anode lead extends forward from a front surface of the anode body in a front-rear direction. The anode lead frame has a standing portion. The anode lead has a front end which is welded to a predetermined region on a rear surface of the standing portion. At least one of the front end of the anode lead and the predetermined region of the standing portion is formed with a laser trace.

According to an aspect of the present invention, the front end of the anode lead is faced to the standing portion and then welded to the rear surface of the standing portion. According to this manufacturing method, when the thus-manufactured solid electrolytic capacitor is coated by an outer coating resin, a space occupied by the anode lead frame can be made small, and the front surface of the anode body can be located close to a front surface of the outer coating resin. As a result, volumetric efficiency of the anode body relative to the solid electrolytic capacitor which includes the outer coating resin can be made large, and thereby the solid electrolytic capacitor having superior characteristics can be obtained. Moreover, when the standing portion and the front end of the anode lead are welded to each other, the laser beam is radiated from the radiation point which is located above the standing portion and is located rearward of the standing portion. According to this radiating manner, the anode lead and the standing portion can be securely welded to each other by relatively small radiation energy, and the solid electrolytic capacitor can be prevented from being degraded in characteristics.

Summarizing the explanation described above, an aspect of the present invention provides a new manufacturing method of a solid electrolytic capacitor in which an anode lead is laser-welded to an anode lead frame and which is suitable for manufacturing a solid electrolytic capacitor having superior characteristics. The solid electrolytic capacitor manufactured by the aforementioned manufacturing method has superior characteristics. Thus, an aspect of the present invention provides a solid electrolytic capacitor which has an anode lead laser-welded to an anode lead frame and which has superior characteristics.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a solid electrolytic capacitor according to an embodiment of the present invention, wherein an outline of inner members covered by and hidden behind an outer coating resin is illustrated with dashed line.

FIG. 2 is a perspective view showing the solid electrolytic capacitor of FIG. 1, wherein an outline of the outer coating resin and a hidden outline of an anode lead are illustrated with dashed line, and a radiation point from which a laser beam is radiated is illustrated with a white circle.

FIG. 3 is a perspective view showing an anode lead frame of the solid electrolytic capacitor of FIG. 2, wherein an outline of a predetermined region to which the laser beam is radiated, an outline of a focus point in the predetermined region and a position of a front edge of a base portion of the anode lead frame are illustrated with dashed line.

FIG. 4 is a flowchart showing manufacturing steps of the solid electrolytic capacitor of FIG. 1.

FIG. 5 is a top view showing the anode lead frame and a cathode lead frame of the solid electrolytic capacitor of FIG. 2, wherein an outline of a body of the solid electrolytic capacitor is illustrated with dashed line, and these illustrated body, anode lead frame and cathode lead frame are under a preparing step.

FIG. 6 is a top view showing the body, the anode lead frame and the cathode lead frame of the solid electrolytic capacitor of FIG. 5, wherein these illustrated body, anode lead frame and cathode lead frame are under a facing step, and an outline of the outer coating resin of the solid electrolytic capacitor is illustrated with dashed line.

FIG. 7 is a side view showing the body, the anode lead frame and the cathode lead frame of the solid electrolytic capacitor of FIG. 6, wherein an outline of the outer coating resin is illustrated with dashed line.

FIG. 8 is a side view showing a part of the solid electrolytic capacitor of FIG. 7, wherein a hidden part of the anode lead frame and a front surface of the outer coating resin are illustrated with dashed line.

FIG. 9 is a side view showing a modification of the solid electrolytic capacitor of FIG. 8, wherein a hidden part of the anode lead frame and an imaginary line extending forward from a lower end of a standing portion of the anode lead frame are illustrated with dashed line.

FIG. 10 is a side view schematically illustrating a laser trace formed on the solid electrolytic capacitor of FIG. 2, wherein an outline of a hidden recessed portion and an outline of a front end of the anode lead before laser-welding are illustrated with dashed line.

FIG. 11 is a rear view schematically illustrating the laser trace of FIG. 10, wherein an outline of the anode lead is illustrated with dashed line.

FIG. 12 is a front view schematically illustrating the laser trace of FIG. 10.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

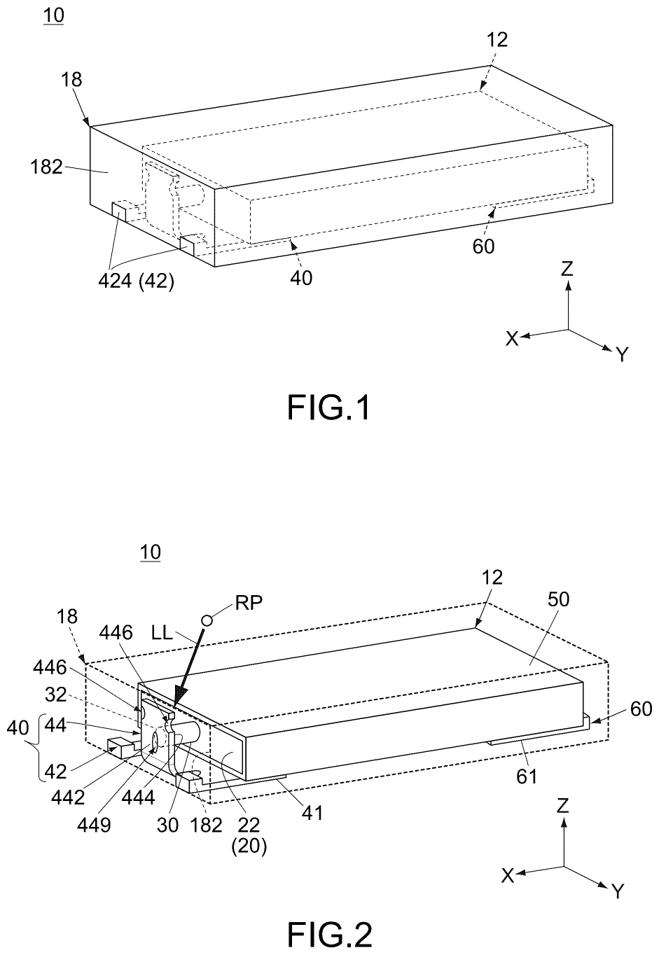

Referring to FIGS. 1 and 2, a solid electrolytic capacitor 10 according to an embodiment of the present invention comprises a body 12 having capacitance, an outer coating resin 18 made of insulator, an anode lead frame 40 made of conductor and a cathode lead frame 60 made of conductor. The solid electrolytic capacitor 10 of the present embodiment has the aforementioned members. However, the present invention is not limited thereto. For example, the solid electrolytic capacitor 10 may further comprise another member in addition to the aforementioned members.

The solid electrolytic capacitor 10 of the present embodiment has a rectangular flat-plate shape in parallel to a horizontal plane (XY-plane). In particular, the solid electrolytic capacitor 10 of the present embodiment has a small size which is about 0.6 mm in an up-down direction perpendicular to the horizontal plane. In other words, the solid electrolytic capacitor 10 has a small thickness. More specifically, the thickness of the solid electrolytic capacitor 10 is smaller than a half a length of a short side of the solid electrolytic capacitor 10 in the horizontal plane. However, the present invention is not limited to the solid electrolytic capacitor 10 which is thin and compact but is applicable to various solid electrolytic capacitors having various shapes and sizes.

The up-down direction of the present embodiment is the Z-direction. In the present embodiment, “upward” means the positive Z-direction, and “downward” means the negative Z-direction. The words related to positions such as the horizontal plane and the up-down direction do not indicate the absolute positional relation relative to the ground but merely indicate a relative positional relation in the figures. For example, in the present embodiment, the solid electrolytic capacitor 10 is configured to be mounted on a principal surface of a circuit board (not shown), and a plane along which this principal surface extends is defined as the horizontal plane.

The body 12 of the present embodiment has a rectangular flat-plate shape substantially in parallel to the horizontal plane (XY-plane). The anode lead frame 40 and the cathode lead frame 60 are fixed to the body 12. The body 12 is located above the anode lead frame 40 and the cathode lead frame 60 as a whole. The outer coating resin 18 is molded of resin so that the body 12, the anode lead frame 40 and the cathode lead frame 60 are buried therein. In other words, the body 12, the anode lead frame 40 and the cathode lead frame 60 are embedded in the outer coating resin 18. However, each of the anode lead frame 40 and the cathode lead frame 60 is partially exposed outward from the outer coating resin 18.

Referring to FIG. 2, an exposed part of the anode lead frame 40 which is exposed from the outer coating resin 18 works as an anode terminal 41, and an exposed part of the cathode lead frame 60 which is exposed from the outer coating resin 18 works as a cathode terminal 61. For example, when the solid electrolytic capacitor 10 is used, the anode terminal 41 and the cathode terminal 61 are soldered on conductive patterns (not shown) formed on an upper surface of a circuit board (not shown), respectively.

The body 12 comprises an anode body 20, an anode lead 30 made of metal such as tantal and a cathode layer 50. Thus, the solid electrolytic capacitor 10 comprises the anode body 20, the anode lead 30 and the cathode layer 50. The anode body 20 of the present embodiment comprises multi-layers which include an anode (not shown) made of valve metal such as tantal and a dielectric layer (not shown) covering the anode. The cathode layer 50 of the present embodiment comprises multi-layers which includes a solid electrolytic layer (not shown) covering the dielectric layer and a surface layer made of conductor such as silver paste. The anode body 20, the anode lead 30 and the cathode layer 50 are located in the outer coating resin 18. The anode body 20, the anode lead 30 and the cathode layer 50 are completely embedded in the outer coating resin 18.

The cathode layer 50 wholly covers the anode body 20 except for a front surface 22 of the anode body 20 in a front-rear direction perpendicular to the up-down direction. The front-rear direction of the present embodiment is the X-direction. In the present embodiment, “forward” means the positive X-direction, and “rearward” means the negative X-direction.

The anode lead 30 of the present embodiment has a cylindrical shape which extends along the front-rear direction. The anode lead 30 has a rear part which is embedded in the anode body 20 and a front part which projects forward from the front surface 22 of the anode body 20. The thus-formed anode lead 30 extends forward from the front surface 22 of the anode body 20 in the front-rear direction.

The anode lead 30 has a front end 32 which is a cut surface cut in a manufacturing step of the anode lead 30. As described later, the front end 32 is welded to the anode lead frame 40. The front end 32 before welding is a planar surface in parallel to a vertical plane (YZ-plane) perpendicular to the front-rear direction and has a small circular shape. The front end 32 has a diameter which is smaller than a size of the body 12 in the up-down direction. For example, the size of the body 12 in the up-down direction is about 0.3 mm, and the diameter of the front end 32 is about 0.15 mm.

The body 12 of the present embodiment has the aforementioned structure and can be manufactured by an existing manufacturing method such as that disclosed in Patent Document 1 (JP 5078827 B), for example. However, the structure and the manufacturing method of the body 12 of the present invention are not specifically limited, provided that the solid electrolytic capacitor 10 is provided with the anode body 20 which holds the anode lead 30. For example, the anode lead 30 may have a polygonal column shape which extends along the front-rear direction. The front end 32 of the anode lead 30 before welding may be a planar surface which is oblique to the front-rear direction.

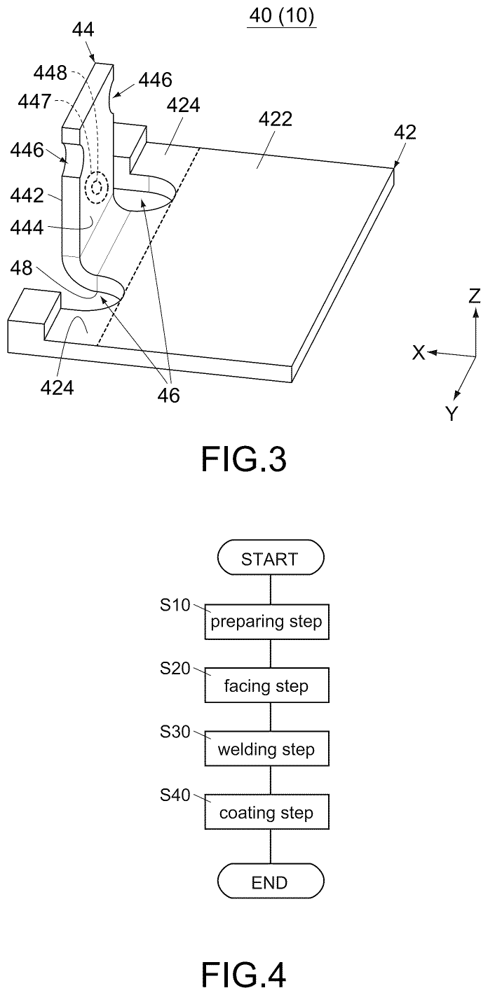

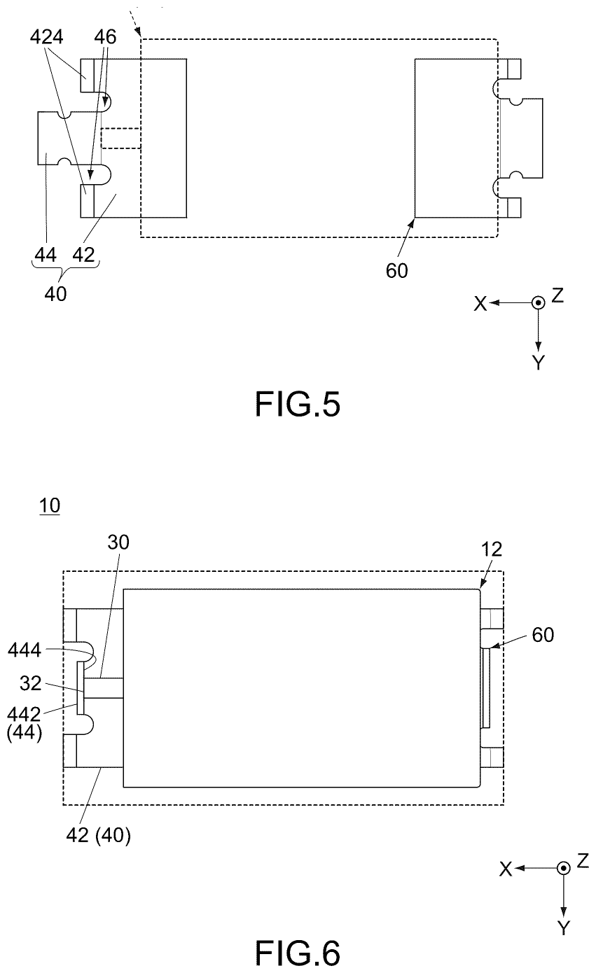

Referring to FIG. 5 together with FIGS. 2 and 3, each of the anode lead frame 40 and the cathode lead frame 60 of the present embodiment is formed by bending a single metal piece of a predetermined shape which is cut out of a metal plate. Thus, each of the anode lead frame 40 and the cathode lead frame 60 is a single metal plate with bends.

Each of the anode lead frame 40 and the cathode lead frame 60 of the present embodiment is formed of metal such as iron or copper which can be relatively easily processed. Accordingly, each of the anode lead frame 40 and the cathode lead frame 60 has a melting point which is rather lower than a melting point of the anode lead 30 which is made of tantal. However, the material, the structure and the manufacturing method of each of the anode lead frame 40 and the cathode lead frame 60 of the present invention are not specifically limited. Moreover, the cathode lead frame 60 may be provided as necessary.

Hereafter, more specific explanation will be made about the anode lead frame 40 of the present embodiment.

Referring to FIG. 3 together with FIG. 2, the anode lead frame 40 of the present embodiment has a base 42 and a standing portion 44. The base 42 has a size slightly smaller than a size of the body 12 in a lateral direction perpendicular to both the up-down direction and the front-rear direction. The standing portion 44 has a size in the lateral direction which is larger than the diameter of the front end 32 of the anode lead 30. The lateral direction of the present embodiment is the Y-direction. The anode lead frame 40 has only the aforementioned portions. However, the present invention is not limited thereto. For example, the anode lead frame 40 may further have another portion in addition to the aforementioned portions.

Referring to FIG. 3, the base 42 of the present embodiment extends along the horizontal plane (XY-plane). The base 42 has a main portion 422 and two legs 424. The main portion 422 has a rectangular flat-plate shape in parallel to the horizontal plane. The main portion 422 has a front edge which extends along the lateral direction. The two legs 424 are connected to opposite sides of the front edge of the main portion 422 in the lateral direction, respectively. Each of the legs 424 extends forward from the front edge of the main portion 422.

The base 42 of the anode lead frame 40 of the present embodiment has the aforementioned structure. However, the present invention is not limited thereto, but the structure of the base 42 can be modified as necessary. Moreover, the base 42 may be provided as necessary.

The standing portion 44 of the present embodiment extends along the vertical plane (YZ-plane) as a whole. In detail, the standing portion 44 is connected to the middle of the front edge of the main portion 422 in the lateral direction. The standing portion 44 extends forward from the front edge of the main portion 422. Then, the standing portion 44 is bent in an arc and extends upward. The standing portion 44 has a front surface 442 and a rear surface 444. Each of the front surface 442 and the rear surface 444 of the present embodiment is a flat surface with no recess and no projection.

The standing portion 44 of the anode lead frame 40 of the present embodiment has the aforementioned structure. However, the present invention is not limited thereto, but the structure of the standing portion 44 can be modified as necessary. For example, each of the front surface 442 and the rear surface 444 may be a curved surface.

Hereafter, explanation will be made about a manufacturing method of the solid electrolytic capacitor 10 (see FIGS. 1 and 2) of the present embodiment.

Referring to FIGS. 1 and 2, it is generally difficult to increase volumetric efficiency of an anode body of a thin and compact solid electrolytic capacitor such as that of the solid electrolytic capacitor 10 of the present embodiment, wherein the volumetric efficiency is the ratio of the volume occupied by the anode body relative to the total volume of the solid electrolytic capacitor including an outer coating resin. However, as described later, according to the manufacturing method of the present embodiment, the volumetric efficiency of the anode body 20 can be made large even when the solid electrolytic capacitor 10 is thin and compact, and thereby the solid electrolytic capacitor 10 can be improved in characteristics.

Referring to FIG. 4 together with FIGS. 1 and 2, the solid electrolytic capacitor 10 of the present embodiment is manufactured via four steps which include a preparing step (S10), a facing step (S20), a welding step (S30) and a coating step (S40). However, the manufacturing method described below is merely an example, and the manufacturing method of the solid electrolytic capacitor 10 can be variously modified. For example, a plurality of the solid electrolytic capacitors 10 may be simultaneously manufactured.

Firstly, in the preparing step (S10), each of three components, or the body 12, the anode lead frame 40 and the cathode lead frame 60, of the solid electrolytic capacitor 10, are formed and prepared. The thus-prepared body 12 has a shape illustrated in FIG. 2. As shown in FIG. 5, each of the anode lead frame 40 and the cathode lead frame 60 prepared as described above is a single metal plate having a predetermined shape. For example, each of the base 42 and the standing portion 44 of the anode lead frame 40 extends along the horizontal plane (XY-plane). Similarly, the whole of the cathode lead frame 60 extends along the horizontal plane.

Referring to FIG. 4 together with FIGS. 5 to 7, in the subsequent facing step (S20), the standing portion 44 of the anode lead frame 40 is bent upward so that the standing portion 44 extends along the vertical plane (YZ-plane). Similarly, a rear part of the cathode lead frame 60 is bent upward so that the rear part extends along the vertical plane. Then, the body 12 is arranged on the base 42 of the anode lead frame 40 and a part of the cathode lead frame 60 which extends along the horizontal plane (XY-plane). Meanwhile, a front part of the body 12 is arranged on the base 42 via an insulating member (not shown). Moreover, a rear part of the body 12 is fixed on the cathode lead frame 60 via a conductive adhesive 70. As a result, the cathode layer 50 of the body 12 is electrically connected with the cathode lead frame 60 via the conductive adhesive 70.

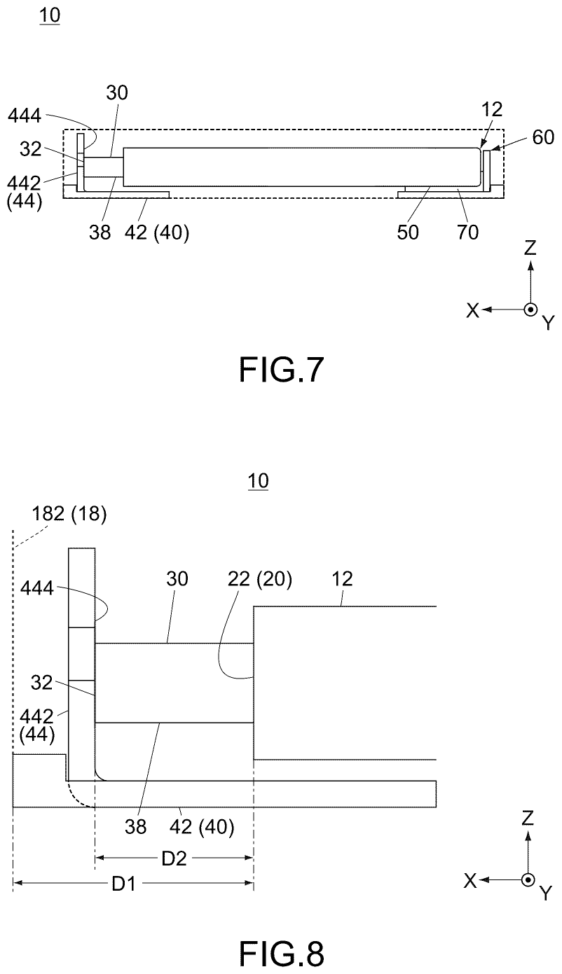

Referring to FIGS. 6 and 7, as a result of the facing step (see FIG. 4), the rear surface 444 of the standing portion 44 is faced to the front end 32 of the anode lead 30. The rear surface 444 of the illustrated standing portion 44 is in contact with the front end 32 of the anode lead 30. However, the present invention is not limited thereto. For example, a small gap may be formed between the rear surface 444 of the standing portion 44 and the front end 32 of the anode lead 30. Instead, the front end 32 of the anode lead 30 may be brought into abutment with the rear surface 444 of the standing portion 44 and may push the rear surface 444 forward.

The rear surface 444 of the standing portion 44 has a predetermined region 447 (see FIG. 3). The predetermined region 447 is a part of the rear surface 444 and is faced to the front end 32 of the anode lead 30 with no distance or a distance formed therebetween. As described later, the predetermined region 447 is configured to be laser-welded to the front end 32 of the anode lead 30. Thus, the manufacturing method of the solid electrolytic capacitor 10 of the present embodiment comprises the facing step (see FIG. 4), or facing the predetermined region 447 on the rear surface 444 of the standing portion 44 and the front end 32 of the anode lead 30 to each other with no distance or a distance formed therebetween. The predetermined region 447 of the present embodiment has a circular shape which corresponds to the front end 32 of the anode lead 30.

Referring to FIG. 5, according to the present embodiment, opposite sides of the standing portion 44 in the lateral direction are formed with two U-shaped grooves 46, respectively. Each of the grooves 46 is located between the standing portion 44 and the leg 424 in the lateral direction. According to this structure, the standing portion 44 can be easily bent so that the standing portion 44 extends along the vertical plane (YZ-plane). However, the present invention is not limited thereto. For example, the anode lead frame 40 may be provided with none of the legs 424. In other words, the whole of the front edge of the base 42 may be connected to the standing portion 44.

Referring to FIG. 4 together with FIGS. 2 and 3, in the subsequent welding step (S30), the front end 32 of the anode lead 30 is laser-welded to the rear surface 444 of the standing portion 44. Referring to FIG. 2 together with FIG. 3, in the laser-welding of the present embodiment, a laser beam LL is radiated from a predetermined radiation point RP toward the predetermined region 447 of the rear surface 444. In detail, the laser beam LL is radiated toward the center of the predetermined region 447 through an upper end of the front end 32 of the anode lead 30. When the laser beam LL is radiated as described above, the front end 32 of the anode lead 30 and the rear surface 444 of the standing portion 44 are partially melted and welded to each other. As a result, the anode terminal 41 of the anode lead frame 40 is electrically connected with the anode body 20 via the anode lead 30.

The radiation point RP of the present embodiment is located above and rearward of the standing portion 44. Thus, the manufacturing method of the solid electrolytic capacitor 10 of the present embodiment comprises the welding step (see FIG. 4), or welding the standing portion 44 and the front end 32 of the anode lead 30 to each other by radiating the laser beam LL toward the predetermined region 447 of the standing portion 44 from the radiation point RP which is located above the standing portion 44 and is located rearward of the standing portion 44.

Referring to FIG. 4 together with FIGS. 1 and 2, in the subsequent coating step (S40), the outer coating resin 18 is molded of resin. In detail, the body 12, which is fixed to the anode lead frame 40 and the cathode lead frame 60, is arranged in a die (not shown). Then, sol-like thermosetting resin is poured into the die. Then, the thermosetting resin is heated and hardened. As a result, the body 12, the anode lead frame 40 and the cathode lead frame 60 are completely covered by the outer coating resin 18 except for the anode terminal 41 and the cathode terminal 61. At this time, the solid electrolytic capacitor 10 has been manufactured.

Referring to FIGS. 2 and 8, according to the present embodiment, the front end 32 of the anode lead 30 is faced to the rear surface 444 of the standing portion 44 and then welded to the rear surface 444 as previously described. According to this manufacturing method, when the thus-manufactured solid electrolytic capacitor 10 is coated by the outer coating resin 18, the space occupied by the anode lead frame 40 can be made small, and the front surface 22 of the anode body 20 can be located close to a front surface 182 of the outer coating resin 18. Thus, a space between the front surface 22 of the anode body 20 and the front surface 182 of the outer coating resin 18 can be reduced. As a result, the volumetric efficiency of the anode body 20 can be made large, and thereby the solid electrolytic capacitor 10 having superior characteristics can be obtained

As described below, the aforementioned laser-welding is preferable to the solid electrolytic capacitor 10 which is thin and compact. In general, the laser beam LL might be scattered during the laser-welding, and the anode body 20 might be damaged by the thus-scattered laser beam LL. However, according to the present embodiment, when the standing portion 44 and the front end 32 of the anode lead 30 are welded to each other, the laser beam LL is radiated from the radiation point RP which is located above the standing portion 44 and is located rearward of the standing portion 44. In other words, the laser beam LL is radiated to the standing portion 44 from a side in the front-rear direction in which the body 12 exists. According to this radiating manner, the body 12 can be reliably prevented from being damaged. Moreover, the space between the front surface 22 of the anode body 20 and the front surface 182 of the outer coating resin 18 can be further reduced by making the radiation angle of the laser beam LL, or the angle of the laser beam LL relative to the front-rear direction, near to 90°.

Moreover, according to the present embodiment, the anode body 20 can be electrically connected with the anode lead frame 40 by merely welding only the small front end 32 of the single anode lead 30 to the standing portion 44. In detail, it is sufficient for the laser beam LL to melt only the upper end of the front end 32 and a part of the anode lead frame 40 which has a low melting point. Thus, according to the present embodiment, the anode lead 30 and the standing portion 44 can be securely welded to each other by relatively small radiation energy, and the anode body 20 can be electrically connected with the anode lead frame 40 while degradation of the characteristics of the solid electrolytic capacitor 10, which might be caused because of the radiation of the laser beam LL, can be prevented.

Summarizing the explanation described above, the present embodiment provides a new manufacturing method of the solid electrolytic capacitor 10 in which the anode lead 30 is laser-welded to the anode lead frame 40 and which is suitable for manufacturing the solid electrolytic capacitor 10 having superior characteristics.

The solid electrolytic capacitor 10 manufactured by the aforementioned manufacturing method has volumetric efficiency larger than that of an existing solid electrolytic capacitor. Thus, the present embodiment provides the solid electrolytic capacitor 10 which has the anode lead 30 laser-welded to the anode lead frame 40 and which has superior characteristics.

The present embodiment provides the solid electrolytic capacitor 10 having large volumetric efficiency in spite of the fact that this solid electrolytic capacitor 10 is thin and compact and provides the manufacturing method suitable for this solid electrolytic capacitor 10. For example, the solid electrolytic capacitor 10 of the present embodiment has a size (length) of about 3.5 mm in the front-rear direction, and a distance D1 between the front surface 182 of the outer coating resin 18 and the front surface 22 of the anode body 20 is 0.3 mm or more but is 0.5 mm or less. According to the present embodiment, the distance D1 can be made 15% or less relative to the length of the solid electrolytic capacitor 10, and thereby the volumetric efficiency of the anode body 20 can be made large.

Hereafter, more specific explanation will be made about the manufacturing method of the present embodiment.

From a viewpoint of increasing the volumetric efficiency of the anode body 20, the distance D1 between the front surface 182 of the outer coating resin 18 and the front surface 22 of the anode body 20 is preferred to be as small as possible. However, when the distance D1 is made small, the distance D2 between the front surface 22 of the anode body 20 and the rear surface 444 of the standing portion 44 is also made small. In general, when the distance D2 is too small, the laser-welding might be difficult, and the anode body 20 might be damaged because of the laser-welding.

For example, according to the YAG laser-welding, which is a typical laser-welding, when the radiated energy of the laser beam LL is large, the anode body 20 might be damaged. More specifically, the standing portion 44 might be largely vaporized, and the vaporized gas might stick on the front surface 22 of the anode body 20 to degrade the anode body 20. On the other hand, when the radiated energy of the laser beam LL is small, secure welding might not be performed. More specifically, when the radiated energy of the laser beam LL is small, so-called open failure might be caused.

In contrast, the laser beam LL of the present embodiment can be generated by the pulse fiber laser. The pulse fiber laser can easily generate the laser beam LL having a small spot diameter. According to an instance where the spot diameter is made small, the density of the radiated energy can be easily made high while the radiated energy is made small.

In detail, referring to FIG. 3 together with FIG. 2, the laser beam LL of the present embodiment is focused on a focus point 448 located at the center of the predetermined region 447. The focus point 448 of the laser beam LL formed on the predetermined region 447 has a short diameter which is 0.01 mm or more but is 0.05 mm or less. In other words, the spot diameter of the laser beam LL of the present embodiment is between 0.01 mm and 0.05 mm (both inclusive). The laser beam LL of the present embodiment has the small spot diameter as described above. Therefore, the laser beam LL of the present embodiment has a small amount of radiated energy in total.

The radiated energy can be easily controlled by generating the laser beam LL by the pulse fiber laser as described above. However, a generation method of the laser beam LL of the present invention is not specifically limited.

According to the present embodiment, the front end 32 of the anode lead 30 and the rear surface 444 of the standing portion 44 can be securely welded to each other by relatively small radiated energy while an operator can watch the front end 32 of the anode lead 30. Accordingly, the anode body 20 can be prevented from being damaged with no additional layer such as a light reflection layer provided on the front surface 22 of the anode body 20. Thus, according to the present embodiment, manufacturing cost of the solid electrolytic capacitor 10 can be reduced.

Referring to FIG. 8, the anode lead 30 of the present embodiment has a lower end 38 which extends straight along the front-rear direction. The front end 32 of the anode lead 30 is a planar surface in parallel to the vertical plane (YZ-plane). In the facing step (see FIG. 4), the front end 32 is faced to and is in surface contact with the rear surface 444 of the standing portion 44 which is a flat surface in parallel to the vertical plane.

According to the aforementioned arrangement, secure welding can be performed by relatively small radiated energy. In detail, the laser beam LL with relatively small radiated energy enables the front end 32 and the rear surface 444 to be securely welded to each other while reducing melt of the anode lead 30 and vaporization of the standing portion 44. However, the present invention is not limited thereto. For example, the arrangement of the anode lead 30 and the standing portion 44 can be variously modified as described below.

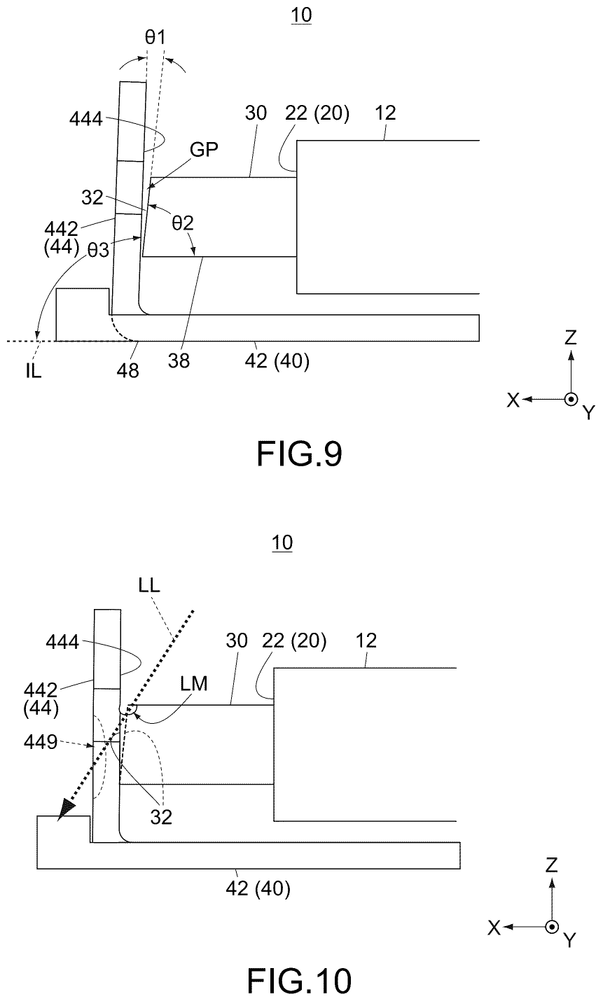

Referring to FIG. 9, a gap GP may be formed between the rear surface 444 of the standing portion 44 and the front end 32 of the anode lead 30 in the facing step (see FIG. 4). When the gap GP is formed, the gap GP is preferred to be widened upward. From a viewpoint of preventing the open failure and making the radiation angle of the laser beam LL large, an angle θ1 made by the rear surface 444 of the standing portion 44 and the front end 32 of the anode lead 30 is preferred to be as small as possible. More specifically, the angle θ1 is preferred to be 13° or less.

Summarizing the explanation described above, when the gap GP is formed between the rear surface 444 of the standing portion 44 and the front end 32 of the anode lead 30 in the facing (see FIG. 4), the gap GP is preferred to be widened upward, and the rear surface 444 of the standing portion 44 and the front end 32 of the anode lead 30 are preferred to make the angle θ1 of 13° or less.

The front end 32 of the anode lead 30 may be oblique to the lower end 38 of the anode lead 30. However, when an angle θ2 made by the front end 32 of the anode lead 30 and the lower end 38 of the anode lead 30 is too small, the laser beam LL (see FIG. 2) with a large radiation angle is hardly radiated through the upper end of the front end 32 of the anode lead 30, and thereby the front end 32 and the rear surface 444 of the standing portion 44 are hardly welded to each other. Accordingly, the angle θ2 is preferred to be close to 90°. More specifically, the angle θ2 is preferred to be 80° or more. However, when the angle θ2 is over 90°, the gap GP is widened downward. According to this structure, a lower part of the standing portion 44 might be vaporized during the laser-welding, and the vaporized gas might stick on the front surface 22 of the anode body 20 to degrade the anode body 20. Accordingly, the angle θ2 is preferred to be 90° or less.

Summarizing the explanation described above, the front end 32 of the anode lead 30 and the lower end 38 of the anode lead 30 are preferred to make the angle θ2 of 80° or more in the facing (see FIG. 4). Moreover, the front end 32 of the anode lead 30 and the lower end 38 of the anode lead 30 are preferred to make the angle θ2 of 90° or less in the facing (see FIG. 4).

In the facing step (see FIG. 4), if the standing portion 44 is bent rearward too much, the front end 32 of the anode lead 30 might be brought into abutment with the standing portion 44 during a process in which the body 12 is arranged on the anode lead frame 40. Therefore, the standing portion 44 is preferred to extend substantially in parallel to the vertical plane (YZ-plane). More specifically, the rear surface 444 of the standing portion 44 and an imaginary line IL which extends forward from a lower end 48 of the standing portion 44 are preferred to make an angle θ3 of 93° or less in the facing.

Hereafter, explanation will be made about the solid electrolytic capacitor 10 (see FIG. 1) of the present embodiment.

As shown in FIG. 6, the standing portion 44 of the present embodiment has a size larger than a size of the front end 32 of the anode lead 30 in the lateral direction. As shown in FIG. 3, the standing portion 44 is formed with two notches 446. The two notches 446 are formed on opposite ends of the standing portion 44 in the lateral direction, respectively. Each of the notches 446 is recessed inward of the standing portion 44 in the lateral direction.

Referring to FIG. 2, according to the previously described manufacturing method, the anode lead 30 and the standing portion 44 are fixed to each other only at a welded part which is located in the vicinity of the front end 32 of the anode lead 30. For example, assuming that none of the notches 446 is formed, when an upward force is applied to the solid electrolytic capacitor 10 mounted on a circuit board (not shown), the standing portion 44 fixed to the circuit board and the anode lead 30 fixed to the standing portion 44 may receive an upward force. As a result, the applied force might be concentrated to the welded part located between the anode lead 30 and the standing portion 44, and thereby the open failure might be caused.

However, according to the present embodiment, the notches 446 are formed, and resin is filled in each of the notches 446. According to this structure, the force applied to the solid electrolytic capacitor 10 can be distributed, and the upward force applied to the anode lead 30 can be reduced. As a result, the force applied to the welded part between the anode lead 30 and the standing portion 44 can be reduced. Moreover, each of the notches 446 works as an anchor which fixes the anode lead frame 40 in the outer coating resin 18, and thereby the body 12, the anode lead frame 40 and the cathode lead frame 60 can be securely fixed in the outer coating resin 18. In particular, a stable anchor effect can be obtained because the two notches 446 are provided at the opposite ends of the standing portion 44 in the lateral direction, respectively.

The notches 446 of the present embodiment are formed as described above and work as described above. However, the present invention is not limited thereto. For example, a shape of each of the notches 446 is not specifically limited. The two notches 446 may be located at positions different from each other in the up-down direction. The notches 446 may be provided as necessary. For example, the size of the standing portion 44 in the lateral direction may be increased upward while none of the notches 446 is provided. According to this structure, an effect similar to that in an instance where the notches 446 are provided can be obtained.

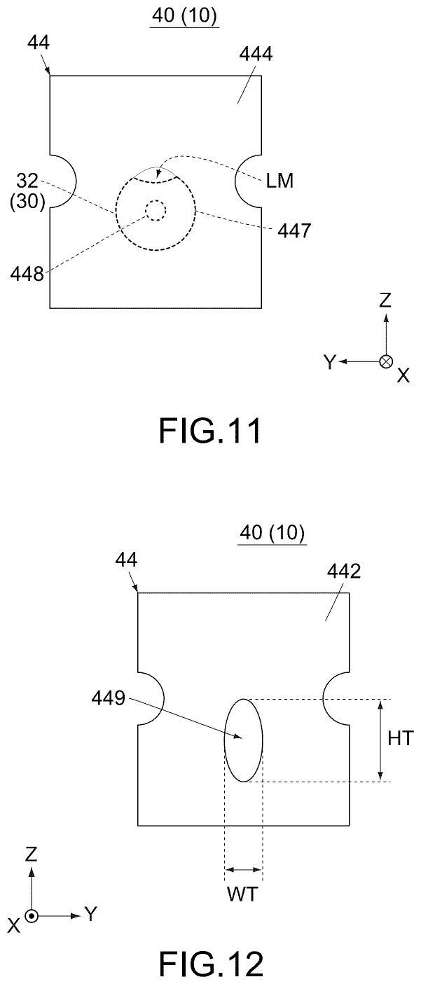

Referring to FIGS. 10 and 11, the solid electrolytic capacitor 10 of the present embodiment is manufactured as previously described. Therefore, the front end 32 of the anode lead 30 is welded to the predetermined region 447 on the rear surface 444 of the standing portion 44. The gap GP (see FIG. 9) which is located between the front end 32 and the rear surface 444 in the facing step (see FIG. 4) is at least partially filled by the melted anode lead 30. Moreover, at least one of the front end 32 of the anode lead 30 and the predetermined region 447 of the standing portion 44 is formed with a laser trace LM.

The laser trace LM is a recess which is formed because of the laser-welding. In other words, the laser trace LM is a cut-out part of the anode lead 30 which is formed because of the laser-welding. A part of the illustrated laser trace LM is located at the upper end of the front end 32 of the anode lead 30 and is recessed downward. Another part of the laser trace LM is located at an upper end of the predetermined region 447 and is slightly recessed forward. The part formed with the laser trace LM is made of an alloy of tantal and iron and is discolored.

The illustrated laser trace LM is formed as described above. However, the illustrated laser trace LM is only a schematically illustrated example, and actual laser traces LM are located at various positions and have various shapes and sizes. As described above, the solid electrolytic capacitor 10 has a structure in which at least one of the front end 32 and the predetermined region 447 is formed with a laser trace LM, i.e., a recess formed because of the laser-welding. This structure implies that the solid electrolytic capacitor 10 is manufactured by the aforementioned manufacturing method.

Referring to FIGS. 10 and 12, the front surface 442 of the illustrated standing portion 44 is formed with a recessed portion 449. The recessed portion 449 is a trace formed by the laser beam LL which passes forward and downward through the standing portion 44. Thus, the recessed portion 449 is a kind of laser trace. Referring to FIG. 12 together with FIG. 11, the recessed portion 449 is located at a position which corresponds to the predetermined region 447 in the vertical plane (YZ-plane) and is recesses rearward from the front surface 442. Referring to FIG. 2, the recessed portion 449 which is formed as described above works as an anchor similar to the notches 446 which fixes the anode lead frame 40 in the outer coating resin 18. Moreover, the recessed portion 449 formed on the front surface 442 of the standing portion 44 implies that the solid electrolytic capacitor 10 is manufactured by the aforementioned manufacturing method.

Referring to FIG. 12, the recessed portion 449 of the present embodiment has an elliptical shape. The recessed portion 449 has a width (first size) WT in the lateral direction and a height (second size) HT in the up-down direction. The second size HT is larger than the first size WT. More specifically, the second size HT is equal to or larger than twice the first size WT. However, the present invention is not limited thereto. The shape, the size and the arrangement of the recessed portion 449 may be variously changed in accordance with a radiation direction and radiated energy of the laser beam LL (see FIG. 10). Moreover, none of the recessed portion 449 is sometimes formed.

Referring to FIG. 2, if the anode lead 30 is laser-welded to a wide area of the anode lead frame 40 by a large amount of radiated energy, the most part of the standing portion 44 of the anode lead frame 40 might be melted. In contrast, the laser-welding of the present embodiment is performed by the laser beam LL with a small amount of radiated energy. As a result, the standing portion 44 is only slightly melted, and the shape of the standing portion 44 before the laser-welding is kept. Accordingly, the shape of the standing portion 44 can be relatively flexibly designed with no consideration of the effect caused by the laser-welding. For example, as previously described, the standing portion 44 can be formed with the two notches 446.

Referring to FIGS. 10 to 12, as previously described, at least one of the front end 32 of the anode lead 30 and the predetermined region 447 of the standing portion 44 is formed with the laser trace LM, and this fact implies that the front end 32 of the anode lead 30 is welded to the predetermined region 447 of the standing portion 44 by the manufacturing method of the present embodiment. However, the present invention is not limited thereto. The volumetric efficiency of the solid electrolytic capacitor 10 can be made larger than that of an existing solid electrolytic capacitor, provided that the anode lead 30 which extends forward from the front surface 22 of the anode body 20 is welded to the standing portion 44 of the anode lead frame 40. Thus, the solid electrolytic capacitor 10 may be manufactured by another manufacturing method different from the manufacturing method of the present embodiment.

Hereafter, explanation will be made about the conductive adhesive 70 (see FIG. 7) of the present embodiment.

Referring to FIG. 7, the cathode layer 50 of the rear part of the body 12 is fixed on the cathode lead frame 60 by the conductive adhesive 70 in the facing step (see FIG. 4). In detail, firstly, the conductive adhesive 70 is applied on the cathode lead frame 60. Then, the cathode layer 50 is placed on the conductive adhesive 70. Then, the solid electrolytic capacitor 10 in the manufacturing process is heated under a temperature rather lower than a soldering temperature so that the conductive adhesive 70 is hardened. As a result, the cathode layer 50 and the cathode lead frame 60 are fixed to each other and electrically connected with each other. According to the present embodiment, the cathode layer 50 can be electrically connected with the cathode lead frame 60 while degradation of the characteristics of the solid electrolytic capacitor 10, which might be caused because of the heat-treatment, can be prevented.

The conductive adhesive 70 of the present embodiment is not specifically limited. For example, the conductive adhesive 70 may be a silver paste which is usually used or may be a conductive metal paste (metalizing paste) different from the silver pate.

The silver paste is an adhesive which contains main component and silver particles. The main component contains thermosetting resin and solvent. The silver particles are distributed in the main component. When the silver paste is heated, the solvent is volatilized so that the main component is shrunk, and thereby the silver particles are brought into contact with each other. As a result, the silver paste after thermal curing has conductivity. However, when the main component is shrunk, the whole of the conductive adhesive 70 is shrunk. As a result, the conductive adhesive 70 might be removed from the cathode layer 50 or the cathode lead frame 60. For example, the cathode lead frame 60 should be formed with an anchor structure such as a structure including depressions and projections so that the cathode layer 50 and the cathode lead frame 60 are securely connected to each other via the silver paste. Such an anchor structure might enlarge the size of the solid electrolytic capacitor 10.

The conductive metal paste is an adhesive which contains main component and various metal particles including low-melting point metal particles. The main component contains thermosetting resin but contains substantially no solvent. The metal particles are distributed in the main component. When the conductive metal paste is heated, the low-melting point metal particles are melted and connect the metal particles to each other. As a result, the conductive metal paste after thermal curing has conductivity. Thus, the conductive metal paste is a metalizing paste. Moreover, when the conductive metal paste is heated, the conductive metal paste is not substantially shrunk. Accordingly, the cathode layer 50 and the cathode lead frame 60 can be securely connected to each other without forming an anchor structure on the cathode lead frame 60. Thus, the solid electrolytic capacitor 10 can be easily made thin and compact. Moreover, according to the connection via the conductive metal paste, variation of the bonding strength between the cathode layer 50 and the cathode lead frame 60 can be reduced in comparison with the connection via the silver paste. Thus, the cathode layer 50 and the cathode lead frame 60 can be electrically stably connected with each other by the conductive metal paste.

According to the present embodiment, the base 42 of the anode lead frame 40 is located just under the cathode layer 50 of the front part of the body 12. The base 42 and the cathode layer 50 should be apart from each other by a relatively large distance in the up-down direction so that the base 42 and the cathode layer 50 are reliably insulated from each other. This arrangement inevitably makes a size (height) of a gap formed between the cathode lead frame 60 and the cathode layer 50 in the up-down direction. The conductive metal paste is suitable for filling such a relatively large gap. However, the silver paste may be used in an instance in which the height of the gap can be made small.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A manufacturing method of a solid electrolytic capacitor comprising an anode body, an anode lead and an anode lead frame, the anode lead extending forward from a front surface of the anode body in a front-rear direction, the anode lead frame having a standing portion, the manufacturing method comprising:
facing a predetermined region on a rear surface of the standing portion and a front end of the anode lead to each other; and
welding the standing portion and the front end of the anode lead to each other by radiating a laser beam toward the predetermined region of the standing portion from a radiation point which is located above the standing portion in an up-down direction perpendicular to the front-rear direction and is located rearward of the standing portion.

2. The manufacturing method as recited in claim 1, wherein when a gap is formed between the rear surface of the standing portion and the front end of the anode lead in the facing, the gap is widened upward, and the rear surface of the standing portion and the front end of the anode lead make an angle of 13° or less.

3. The manufacturing method as recited in claim 2, wherein the front end of the anode lead and a lower end of the anode lead make an angle of 80° or more in the facing.

4. The manufacturing method as recited in claim 1, wherein the rear surface of the standing portion and an imaginary line which extends forward from a lower end of the standing portion make an angle of 93° or less in the facing.

5. The manufacturing method as recited in claim 1, wherein the front end of the anode lead and a lower end of the anode lead make an angle of 90° or less in the facing.

6. The manufacturing method as recited in claim 1, wherein a focus point of the laser beam formed on the predetermined region has a short diameter which is 0.01 mm or more but is 0.05 mm or less.

7. A solid electrolytic capacitor comprising an anode body, an anode lead and an anode lead frame, wherein:
the anode lead extends forward from a front surface of the anode body in a front-rear direction;
the anode lead frame has a standing portion;
the anode lead has a front end which is welded to a predetermined region on a rear surface of the standing portion; and
at least one of the front end of the anode lead and the predetermined region of the standing portion is formed with a laser trace.

8. The solid electrolytic capacitor as recited in claim 7, wherein:
the standing portion has a size larger than a size of the front end of the anode lead in a lateral direction perpendicular to the front-rear direction;
the standing portion is formed with two notches;
the two notches are formed on opposite ends of the standing portion in the lateral direction, respectively; and
each of the notches is recessed inward of the standing portion in the lateral direction.

9. The solid electrolytic capacitor as recited in claim 7, wherein:
the standing portion has a front surface which is formed with a recessed portion; and
the recessed portion is located at a position which corresponds to the predetermined region in a vertical plane perpendicular to the front-rear direction and is recessed rearward.

10. The solid electrolytic capacitor as recited in claim 9, wherein:
the recessed portion has an elliptical shape;
the recessed portion has a first size in a lateral direction perpendicular to the front-rear direction and has a second size in an up-down direction perpendicular to both the front-rear direction and the lateral direction; and
the second size is larger than the first size.

11. The solid electrolytic capacitor as recited in claim 10, wherein the second size is equal to or larger than twice the first size.

12. The solid electrolytic capacitor as recited in claim 7, wherein:
the solid electrolytic capacitor comprises an outer coating resin;
the anode body and the anode lead are located in the outer coating resin; and
a distance between a front surface of the outer coating resin and the front surface of the anode body is 0.3 mm or more but is 0.5 mm or less.

13. The solid electrolytic capacitor as recited in claim 7, wherein:
the solid electrolytic capacitor comprises a cathode layer and a cathode lead frame;
the cathode layer is electrically connected with the cathode lead frame via a conductive adhesive; and
the conductive adhesive is a conductive metal paste.
